(19) United States
(12) Patent Application Publication
(10) Pub. No.: US 2019/0105819 A1
(43) Pub. Date: Apr. 11, 2019

(54) FRP SHEET PRESS MOLDING METHOD AND DEVICE AND FRP MOLDED ARTICLE

(71) Applicant: HONDA MOTOR CO., LTD., Minato-ku (JP)

(72) Inventors: Motoki Sakurai, Hagagun, Tochigi (JP); Kenji Hayashi, Hagagun, Tochigi (JP)

(21) Appl. No.: 16/086,734

(22) PCT Filed: Mar. 23, 2017
(86) PCT No.: PCT/JP2017/011774

§ 371 Date: Sep. 20, 2018

(30) Foreign Application Priority Data
Mar. 24, 2016 (JP) 2016-060727

(51) Int. Cl. B29C 45/14; B29C 70/46

(52) U.S. Cl. CPC B29C 45/1418; B29K 2307/04; B29C 70/46

(57) ABSTRACT

Provided are: an FRP sheet press molding method and device that are capable of improving production efficiency; and an FRP molded article. The FRP sheet press molding method, whereby a press-molded article PM is molded using a fiber-reinforced plastic sheet material SM1, comprises: a press step in which molds 2, 3 are closed and the heated sheet material SM1 is press-molded interior a cavity 5; and a filling step in which the closed state of the molds 2, 3 is maintained from the press step and a molten resin MP is pressure-injected from an injection section IP1 formed in one surface of the sheet material SM1, towards the interior IN1 of the sheet material SM1.

### TECHNICAL FIELD

The present invention relates to a FRP sheet press molding method and device which molds a press molded article using carbon reinforced plastic, as well as an FRP molded article.

### BACKGROUND ART

Cited Document 1 discloses a molding technique for molded articles of a 3-layer structure in which FRP material (carbon reinforced plastic) interposes resin.

Patent Document 1: Japanese Patent No. 2917372

### DISCLOSURE OF THE INVENTION

### Problems to be Solved by the Invention

To realize the molding technology described in Cited Document 1, it is necessary to prepare two FRP sheets, and thus production efficiency is poor.

The present invention has an object of providing an FRP sheet press molding method and device capable of improving production efficiency, as well as an FRP molded article.

### Means for Solving the Problems

In order to achieve the above-mentioned object, the present invention provides an FRP sheet press molding method of molding a press molded article (for example, the press molded article PM described later) using fiber reinforced plastic (for example, the sheet material SM, SM1, SM2 described later), the method including: a pressing step of press molding, inside of a cavity (for example, the cavity 5 described later) by closing molds (for example, the dies 2, 3 described later), the fiber reinforced plastic which was heated; and a filling step of pressure injecting resin to the interior (for example, the interior IN1, IN2 described later) of the fiber reinforced plastic from an injection port (for example, the injection port IP1, IP2 described later) formed in one surface (for example, the lower surface LS1 described later) of the fiber reinforced plastic, while maintaining a closed state of the molds from the pressing state, in which the press molded article is molded to dispose a layer of the resin (for example, the resin PR described later) between layers (for example, the top layer TL and back layer BL described later) of the fiber reinforced plastic.

In this way, it is possible to mold the press molded article arranging the resin layer (plastic layer) between the fiber reinforced plastic layers by way of the FRP sheet press molding method, and thus it is possible to mold a press molded article having sufficient strength, without using more fibers than necessary. In addition, it is possible to raise the production efficiency of the press molded article.

Alternatively, in order to achieve the above-mentioned object, the present invention provides an FRP sheet press molding device for molding a press molded article (for example, the press molded article PM described later) from fiber reinforced plastic (for example, the sheet material SM, SM1, SM2 described later) using molds (for example, the dies 2, 3 described later), in which the molds include a sprue (for example, the sprue 7 described later) connecting to a cavity (for example, the cavity 5 described later); the FRP sheet press molding device press molds, inside of the cavity by closing the molds, the fiber reinforced plastic which was heated, and then pressure injects resin (for example, the molten resin MP described later) via the sprue to the interior (for example, the interior IN1, IN2 described later) of the fiber reinforced plastic from an injection port (for example, the injection port IP1, IP2 described later) formed in one surface (for example, the lower surface LS1 described later) of the fiber reinforced plastic, while maintaining a closed state of the molds; and the press molded article is molded to dispose a layer of the resin (for example, the resin PR described later) between layers (for example, the top layer TL and back layer BL described later) of the fiber reinforced plastic.

In this way, it is possible to mold the press molded article arranging the resin layer (plastic layer) between the fiber reinforced plastic layers by way of the FRP sheet press molding device, and thus it is possible to mold a press molded article having sufficient strength, without using more fibers than necessary. In addition, it is possible to raise the production efficiency of the press molded article.

Alternatively, in order to achieve the above-mentioned object, the present invention provides an FRP molded article including: fiber reinforced plastic (for example, the sheet material SM, SM1, SM2 described later) that was press molded inside of a cavity (for example, the cavity 5 described later) of molds (for example, the dies 2, 3 described later); and resin (for example, the molten resin MP described later) which was pressure injected to the interior (for example, the interior IN1, IN2 described later) of the fiber reinforced plastic from an injection port (for example, the injection port IP1, IP2 described later) formed in one surface (for example, the lower surface LS1 described later) of the fiber reinforced plastic, in which the FRP molded article disposes a layer of the resin (for example, the resin PR described later) between layers (for example, the top layer TL and back layer BL described later) of the fiber reinforced plastic.

In this way, since disposing the resin layer (plastic layer) between fiber reinforced plastic layers according to the FRP molded article, it is possible to produce without using more fibers than necessary, and it is possible to have sufficient strength. In addition, if being such an FRP molded article, production will be easy, and thus it is possible to improve production efficiency.

### Effects of the Invention

According to the present invention, it is possible to provide an FRP sheet press molding method and device capable of improving production efficiency, as well as an FRP molded article.

### BRIEF DESCRIPTION OF THE DRAWINGS

FIG. 1 is a longitudinal sectional view showing an FRP sheet press molding device 1 according to an embodiment of the present invention;

FIG. 2 is a cross-sectional view showing characteristics of a sheet material SM, with (A) showing the state prior to heating, and (B) showing a state after heating;

FIG. 3 is an enlarged view of the FRP sheet press molding device 1 showing the flow of molding a press molded article PM, with (A) showing a state of the temperatures of the top layer TL and back layer BL of the sheet material SM lowering, (B) showing a state of the sheet material SM being pressed, and (C) showing a state of molten resin being pressure injected to the interior of the sheet material SM;

FIG. 4 is an enlarged view of the FRP sheet press molding device 1 showing the flow of molding the press molded particle PM, with (A) showing a state immediately before the molten resin MP being pressure injected to the interior IN1 of the sheet material SM, and (B) showing a state of the molten resin MP being pressure injected to the interior IN1 of the sheet material SM;

FIG. 5 is a cross-sectional view of the press molded article PM;

FIG. 6 provides cross-sectional pictures of the press molded article PM, with (A) being a longitudinal sectional view, (B) being a cross-sectional view looking in the arrow VIB-VIB direction of (A), (C) being a cross-sectional view looking in the arrow VIC-VIC direction of (A), and (D) being a cross-sectional view looking in the arrow VID-VID direction of (A);

FIG. 7 provides cross-sectional views showing characteristics of two stacked sheet materials SM1, SM2, with (A) showing a state prior to heating, and (B) showing a state after heating; and

FIG. 8 provides enlarged views of the FRP sheet press molding device 1 showing the flow of molding another press molded article, with (A) showing a state prior to molten resin MP being pressure injected to the interior IN2 of the sheet materials SM1, SM2, and (B) showing a state in which molten resin MP was pressure injected to the interior IN2 of the sheet material SM1, SM2.

### PREFERRED MODE FOR CARRYING OUT THE INVENTION

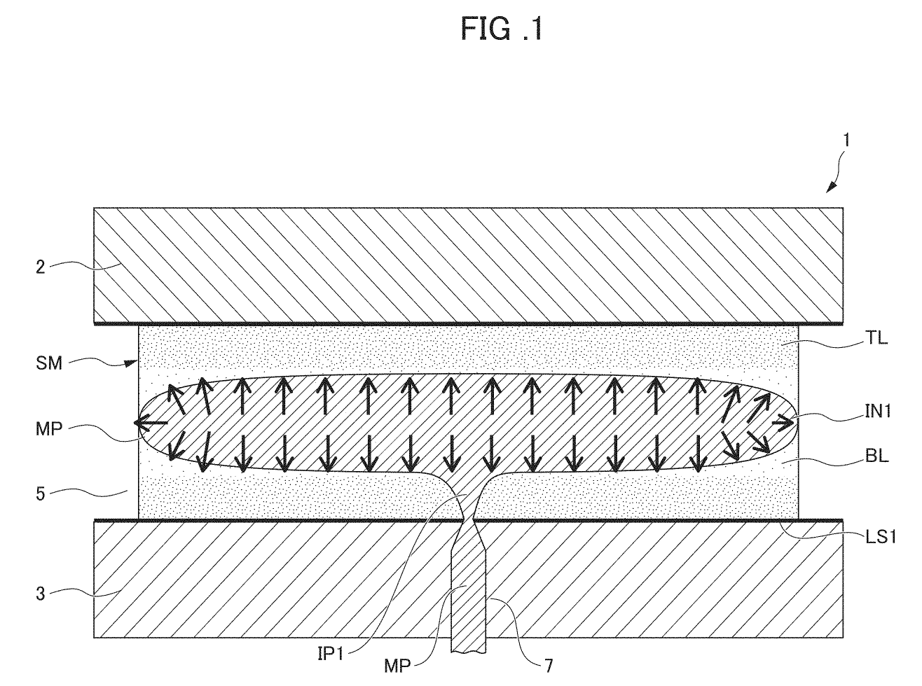

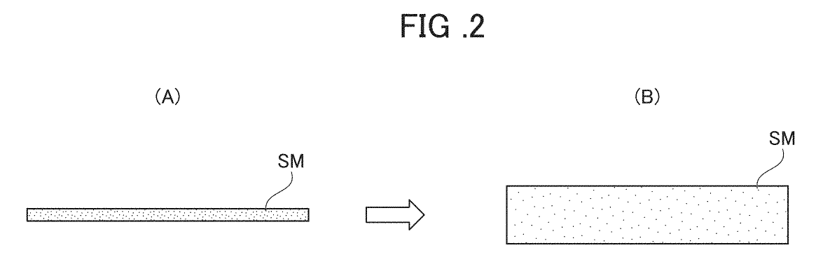

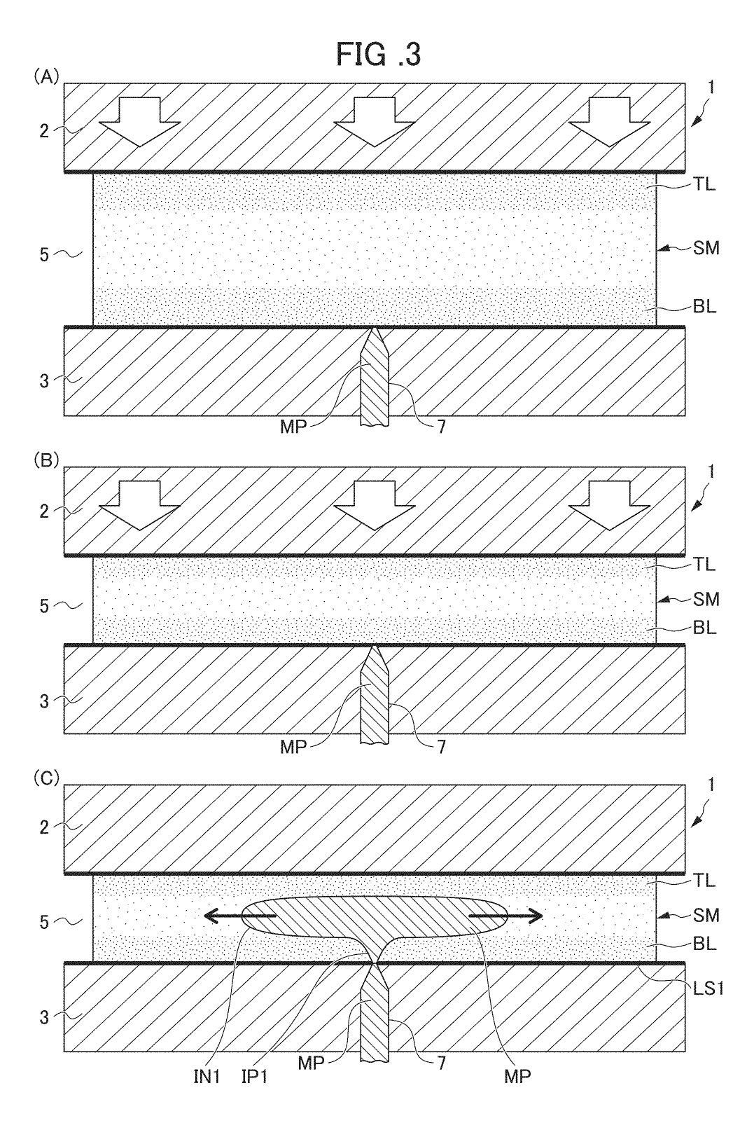

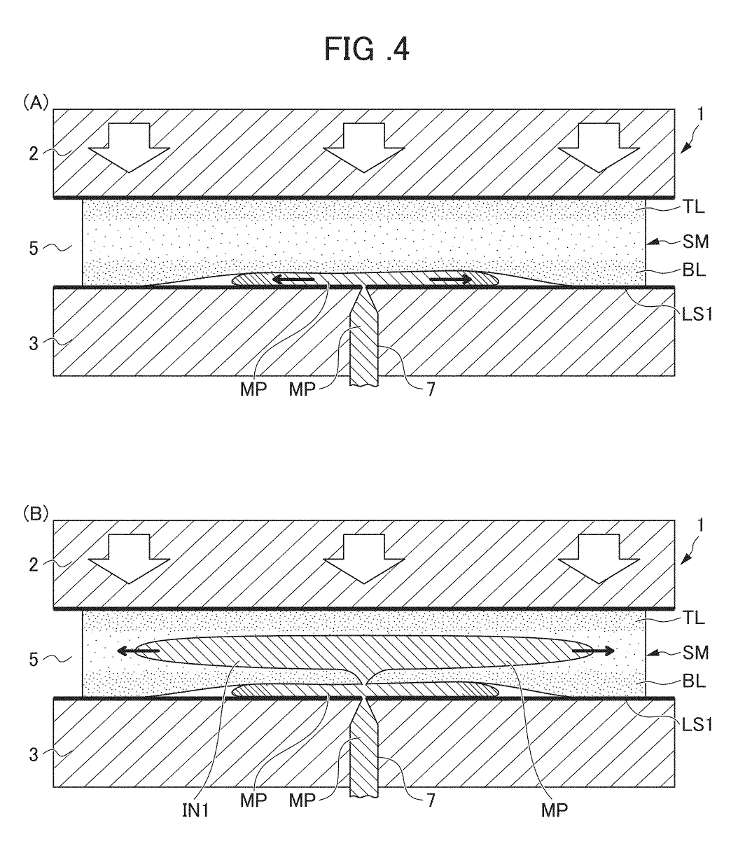

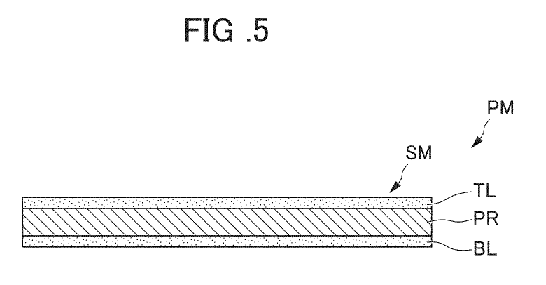

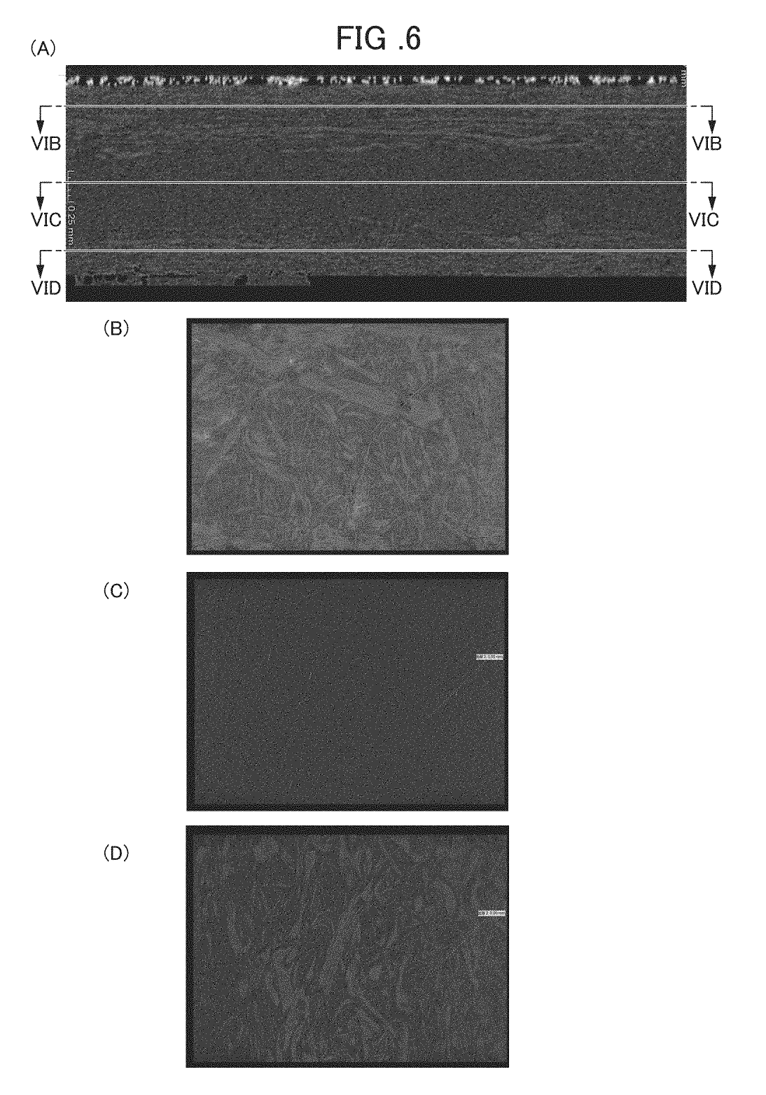

An embodiment of the present invention will be explained in detail while referencing the drawings. FIG. 1 is a longitudinal sectional view showing an FRP sheet press molding device 1 according to the embodiment of the present invention. FIG. 2 is a cross-sectional view showing characteristics of a sheet material SM. FIG. 2(A) shows a state prior to heating. FIG. 2(B) shows a state after heating. FIG. 3 provides enlarged views of the FRP sheet press molding device 1 showing the flow of molding a press molded article PM. FIG. 3(A) shows a state in which the temperatures of the top layer TL and back layer BL of the sheet material SM lowers. FIG. 3(B) shows a state in which the sheet material SM has been pressed. FIG. 3(C) shows a state in which molten resin MP is pressure injected to the interior IN1 of the sheet material SM. FIG. 4 provides enlarged views of the FRP sheet press molding device 1 showing the flow of molding the press molded article PM. FIG. 4(A) shows a state immediately before the molten resin MP is pressure injected to the interior IN1 of the sheet material SM. FIG. 4B shows a state of the molten resin MP being pressure injected to the interior IN1 of the sheet material SM. FIG. 5 is a cross-sectional view of the press molded article PM. FIG. 6 provides cross-sectional pictures of the press molded article PM. FIG. 6(A) is a longitudinal sectional view. FIG. 6(B) is a cross-sectional view looking in the arrow VIB-VIB direction of FIG. 6(A). FIG. 6(C) is a cross-sectional view looking in the arrow VIC-VIC direction of FIG. 6(A). FIG. 6(D) is a cross-sectional view looking in the arrow VID-VID direction of FIG. 6(A).

The FRP sheet press molding device 1 shown in FIG. 1 is used upon producing a press molded article (FRP molded article) PM (refer to FIG. 5), by press molding or the like a sheet material (FRP (Glass/Carbon) sheet material) SM of carbon reinforced plastic (FRP: Fiber Reinforced Plastics). More specifically, the FRP sheet press molding device 1 includes a pair of upper and lower dies 2, 3, and an injection molding machine (omitted from illustration), etc.

The pair of upper and lower dies 2, 3 are brought into contact with each other by the injection molding machine (omitted from illustration), and a force of several hundred tons or more is applied. This pair of upper and lower dies 2, 3 constitutes a cavity 5 serving as a space pressing the sheet material SM1 therebetween. The lower die 3 has a sprue 7 connected to the cavity 5. In the cavity 5, the sheet material SM is disposed, and the molten resin MP is pressure injected from the injection molding machine via the sprue 7.

The injection molding machine (omitted from illustration) applies force of at least hundreds of tons by causing the pair of upper and lower dies 2, 3 to come into contact with each other. This injection molding machine pressure injects molten resin MP to the cavity 5 configured between each of the pair of upper and lower dies 2, 3 via the sprue 7.

Although the details are described later, the molten resin MP pressure injected to the cavity 5 infiltrates to the interior IN1 of the sheet material SM from an injection port IP1 formed in the lower surface LS1, which is one surface of the sheet material SM. In other words, the injection molding machine (omitted from illustration) pressure injects the molten resin MP via the sprue 7 to the interior IN1 of the sheet material SM, from the injection port IP1 formed in the lower surface LS1 of the sheet material SM.

In this way, the FRP sheet press molding device 1 molds the press molded article PM (refer to FIG. 5) made by arranging a layer of resin PR (refer to FIG. 5) between the top layer and back layer BL of the sheet material SM.

Next, an FRP sheet press molding method by the FRP sheet press molding device 1 will be explained while referencing FIGS. 2 and 3.

The FRP sheet press molding method by the FRP sheet press molding device 1 is a method of molding the press molded article PM using the sheet material SM. This FRP sheet press molding method includes a pressing step and a refilling step.

The sheet material SM expands while generating voids (bubbles) by heating, and becomes felt-like and pliant (refer to FIG. 2 (A) to FIG. 2(B)).

In the pressing step, the heated sheet material SM is arranged in the cavity 5 by closing the dies 2, 3, as shown in FIG. 3(A). In the sheet material SM, the temperatures of the top layer TL and back layer BL lower by contacting with the dies 2, 3, and the top layer TL and back layer BL shrink and harden. Subsequently, as shown in FIG. 3(B), the upper die 2 is lowered until the clearance of a predetermined product sheet thickness, and the sheet material SM is pressed within the cavity 5.

In the filling step, as shown in FIG. 3(C), the molten resin MP is pressure injected into the cavity 5 via the sprue 7 while maintaining the state closing the dies 2, 3 from the pressing step. The hole serving as the injection port IP1 is formed in the lower surface LS1, which is one surface of the sheet material SM, and the molten resin MP is thereby pressure injected from this injection port IP1 to interior IN1 of the sheet material SM. In other words, in the filling step, the molten resin MP is pressure injected to the interior IN1 of the sheet material SM, from the injection port IP1 formed in the lower surface LS1, which is one surface of the sheet material SM, while maintaining the state closing the dies 2, 3 from the pressing step.

By the molten resin MP cooling and hardening, the press molded article PM (refer to FIG. 5) arranging a layer of resin PR (refer to FIG. 5) between the top layer TL and back layer BL of the sheet material SM is molded.

Next, the mechanism by which the injection port IP1 is formed in the FRP sheet press molding method by the FRP sheet press molding device 1 will be explained while referencing FIG. 4.

The molten resin MP pressure injected to the cavity 5 via the sprue 7 in the pressing step, even if assuming to flow between the back layer LS1 and the lower die 3 as shown in FIG. 4(A), will be cooled and cure at the die 3, whereby the flow between the back layer LS1 and die 3 will stop.

Then, as shown in FIG. 4(B), the hole serving as the injection port IP1 is formed, and the molten resin MP pressure injected to the cavity 5 via the sprue 7 flows in the direction of less resistance; therefore, it flows to the interior IN1 of the sheet material SM which has low flow resistance, whereby a 3-layer structure can be made.

Next, the structure of the press molded article PM molded by the FRP sheet press molding method using the FRP sheet press molding device 1 will be explained while referencing FIGS. 5 and 6.

As shown in FIGS. 5 and 6, the press molded article (FRP molded article) PM has a 3-layer structure arranging a layer of resin PR between the top layer TL and back layer BL of the sheet material SM. The sheet material SM is press molded within the cavity 5 of the dies 2, 3. The resin PR is cooled and cured after being pressure injected to the interior IN1 of the sheet material SM (refer FIG. 1), from the injection port IP1 (refer to FIG. 1) formed in the lower surface LS1 (refer to FIG. 1), which is one surface of the sheet material SM.

According to the FRP sheet press molding method of the present embodiment explained above, the following such effects are exerted.

In other words, the FRP sheet press molding method is a method of molding the press molded article PM using the sheet material SM of fiber reinforced plastic, and includes: a pressing step of press molding the heated sheet material SM within the cavity 5 by closing the dies 2, 3; and a filling step of pressure injecting the resin material MP to the interior IN1 of the sheet material SM, from the injection port IP1 formed in the lower surface LS1, which is one surface of the sheet material SM, while maintaining the state closing the dies 2, 3 from the pressing step, thereby molding the press molded article PM arranging a layer of the resin PR between the top layer TL and back layer BL of the sheet material SM.

In this way, it is possible to mold the press molded article PM arranging the resin PR layer between the top layer TL and back layer BL of the sheet material SM by way of the FRP sheet press molding method, and thus it is possible to mold a press molded article PM having sufficient strength, without using more fibers than necessary. In addition, it is possible to raise the production efficiency of the press molded article PM.

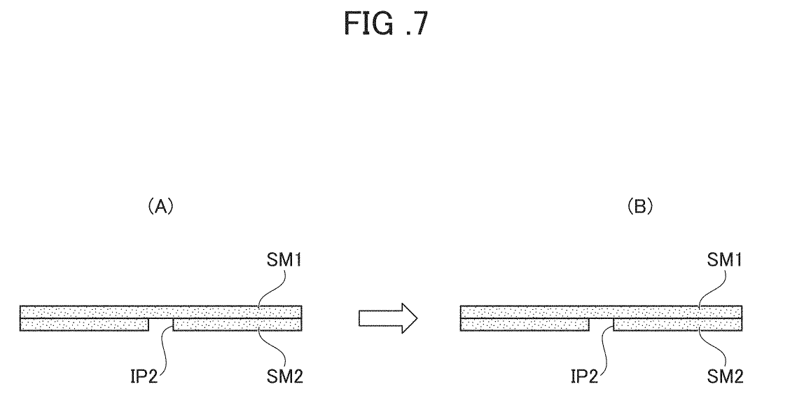

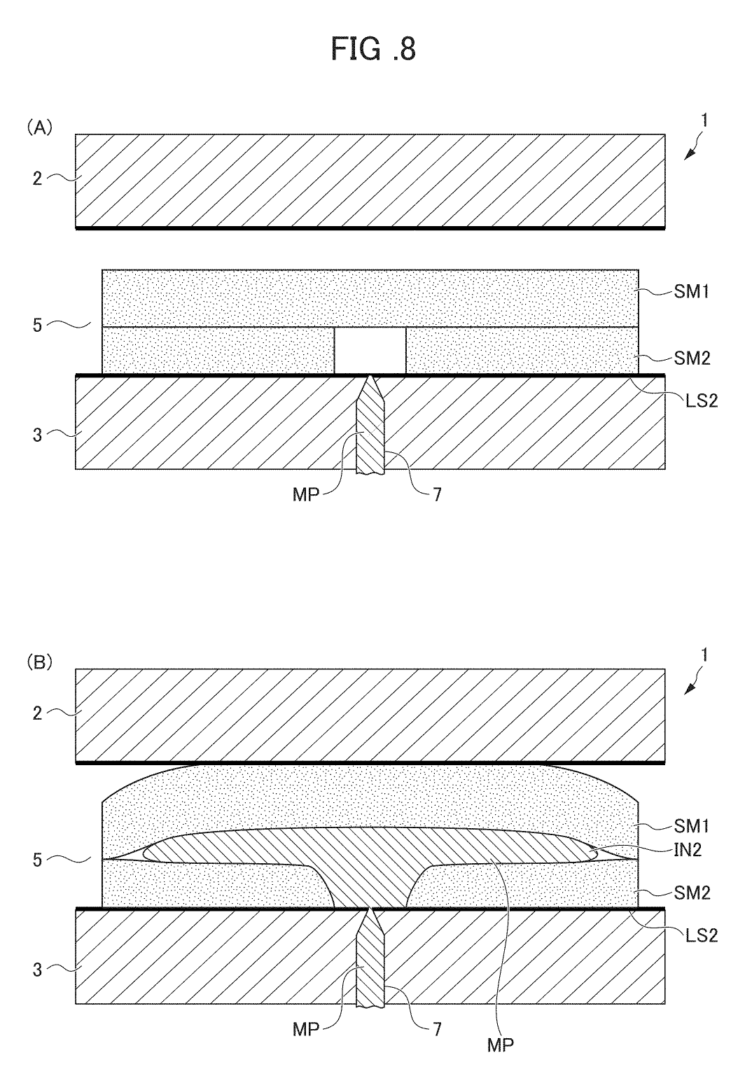

Next, another embodiment of the present invention will be explained in detail while referencing the drawings. FIG. 7 is a cross-sectional view showing the characteristics of two stacked sheet materials SM1, SM2. FIG. 7(A) shows a state prior to heating. FIG. 7(B) shows a state after heating. FIG. 8 provides enlarged views of the FRP sheet press molding device 1 showing the flow of molding another press molded article (omitted from illustration). FIG. 8(A) shows a state prior to the molten resin MP being pressure injected to the interior IN2 of the sheet materials SM1, SM2. FIG. 8(B) shows a state of the molten resin MP being pressure injected to the interior IN2 of the sheet materials SM1, SM2. It should be noted that the FRP sheet press molding device 1 according to the present embodiment is the same configuration as the aforementioned FRP sheet press molding device 1, and molds a press molded article (omitted from illustration) using two stacked sheet materials SM1, SM2 in place of the aforementioned sheet material SM.

Although the details are described later, the molten resin MP that was pressure injected to the cavity 5 infiltrates to the interior IN2 of the two stacked sheet materials SM1, SM2, from the injection port IP2 formed in the lower surface LS2, which is one surface of the two stacked sheet materials SM1, SM2. In other words, the injection molding machine (omitted from illustration) pressure injects the molten resin MP via the sprue 7 to the interior IN2 of the two stacked sheet materials SM1, SM2, from the injection port IP2 formed in the lower surface LS2 of the two stacked sheet materials SM1, SM2.

In this way, the FRP sheet press molding device 1 molds the press molded article (omitted from illustration) arranging a layer of resin between the two stacked sheet materials SM1, SM2.

Next, the FRP sheet press molding method by the FRP sheet press molding device 1 will be explained while referencing FIGS. 7 and 8.

The FRP sheet press molding method by the FRP sheet press molding device 1 is a method of molding a press molded article (omitted from illustration) using the two stacked sheet materials SM.

Contrary to the aforementioned sheet material SM (refer to FIG. 2), the two stacked sheet materials SM1, SM2 will not expand, even in a state of heating (refer to FIG. 7(A) to FIG. 7(B)).

In the pressing step, the heated two stacked sheet materials SM1, SM2 are arranged in the cavity 5 by closing the dies 2, 3, as shown in FIG. 8(A). At this time, the injection port IP2 formed in the lower surface LS2 of the two stacked sheet materials SM1, SM2 is made to continue to the sprue 7.

In the filling step, as shown in FIG. 8(B), the molten resin MP is pressure injected to the cavity 5 via the sprue 7, while maintaining the state closing the dies 2, 3 from the pressing step. The molten resin MP is thereby pressure injected to the interior IN2 of the two stacked sheet materials SM1, SM2, from the injection port IP2 formed in the lower surface LS2 of the two stacked sheet materials SM1, SM2. In other words, in the filling step, the molten resin MP is pressure injected to interior IN2 of the two stacked sheet materials SM1, SM2, from the injection port IP2 formed in the lower surface LS2, which is one surface of the two stacked sheet materials SM1, SM2, while maintaining the state closing the dies 2, 3 from the pressing step.

By the molten resin MP cooling and hardening, the press molded article (omitted from illustration) arranging a layer of resin (omitted from illustration) between the two stacked sheet materials SM1, SM2 is molded.

According to the FRP sheet press molding method of the present embodiment explained above, the following such effects are exerted.

Specifically, the FRP sheet press molding method is a method of molding the press molded article (omitted from illustration) using the two stacked sheet materials SM1, SM2 of fiber reinforced plastic, the method including: a pressing step of press molding two heated stacked sheet materials SM1, SM2 within the cavity 5 by closing the dies 2, 3; and a filling step of pressure injecting the molten resin MP to the interior IN2 of the two stacked sheet materials SM1, SM2, from the injection port IP2 formed in the lower surface LS1, which is one surface of the two stacked sheet materials SM1, SM2, while maintaining the closed state of the dies 2, 3 from the pressing step, thereby molding a press molded article (omitted from illustration) arranging resin (omitted from illustration) between the two stacked sheet materials SM1, SM2.

In this way, according to the FRP sheet press molding method, it is possible to mold a press molded article (omitted from illustration) arranging a resin (omitted from illustration) layer between the two stacked sheet materials SM1, SM2, and thus possible to mold a press molded article having sufficient strength without using more fibers than necessary. In addition, it is possible to raise the production efficiency of the press molded article.

The present invention is not to be limited to the above-mentioned embodiment, and modifications, improvements, etc. within a scope that can achieve the object of the present invention are also encompassed by the present invention.

### EXPLANATION OF REFERENCE NUMERALS

1 FRP sheet press molding device
2, 3 die (mold)
5 cavity
7 sprue
SM, SM1, SM2 sheet material (fiber reinforced plastic)
LS1, LS2 lower surface (one surface)
IP1, IP2 injection port
IN1, IN2 interior
TL top layer
BL back layer
MP molten resin (resin)
PR resin
PM press molded article (FRP molded article)

1. An FRP sheet press molding method of molding a press molded article using fiber reinforced plastic, the method comprising:
a pressing step of press molding, inside of a cavity by closing molds, the fiber reinforced plastic which was heated; and
a filling step of pressure injecting resin to the interior of the fiber reinforced plastic from an injection port formed in one surface of the fiber reinforced plastic, while maintaining a closed state of the molds from the pressing state,
wherein the press molded article is molded to dispose a layer of the resin between layers of the fiber reinforced plastic.

2. An FRP sheet press molding device for molding a press molded article from fiber reinforced plastic using molds,
wherein the molds include a sprue connecting to a cavity,
wherein the FRP sheet press molding device press molds, inside of the cavity by closing the molds, the fiber reinforced plastic which was heated, and
then pressure injects resin via the sprue to the interior of the fiber reinforced plastic from an injection port formed in one surface of the fiber reinforced plastic, while maintaining a closed state of the molds,
wherein the press molded article is molded to dispose a layer of the resin between layers of the fiber reinforced plastic.

3. An FRP molded article, comprising:
fiber reinforced plastic that was press molded inside of a cavity of molds; and
resin which was pressure injected to the interior of the fiber reinforced plastic from an injection port formed in one surface of the fiber reinforced plastic
wherein the FRP molded article disposes a layer of the resin between layers of the fiber reinforced plastic.
